(19) United States
(12) Patent Application Publication
(10) Pub. No.: US 2013/0029252 A1
(43) Pub. Date: Jan. 31, 2013

(54) FUEL CELL AND ELECTROCATALYST

(71) Applicants: Man-Yin Lo, Hsinchu City (TW); Ying-Chieh Chen, Dacun Township (TW); Mei-Yuan Chang, Hsinchu (TW)

(72) Inventors: Man-Yin Lo, Hsinchu City (TW); Ying-Chieh Chen, Dacun Township (TW); Mei-Yuan Chang, Hsinchu (TW)

(21) Appl. No.: 13/361,624

(22) Filed: Jan. 30, 2012

(30) Foreign Application Priority Data
Jul. 28, 2011 (TW) 100126739

(51) Int. Cl. H01M 4/92; C01B 25/08

(52) U.S. Cl. 429/524; 423/299

(57) ABSTRACT

An embodiment of the invention provides an electrocatalyst, including a four-element catalyst having a formula of XYZP, wherein X is Pt or Pd, Y and Z are different elements selected from Group 6, Group 8, Group 9, or Group 11 elements, and P is phosphorous, wherein Group 6 elements include Cr, Mo, or W, Group 8 elements include Fe, Ru, or Os, Group 9 elements include Co, Rh, or Ir, and Group 11 elements include Cu, Ag, or Au.

### CROSS REFERENCE TO RELATED APPLICATIONS

This application claims priority of Taiwan Patent Application No. 100126739, filed on Jul. 28, 2011, the entirety of which is incorporated by reference herein.

### BACKGROUND OF THE INVENTION

1. Field of the Invention

The present invention relates to an electrocatalyst, and in particular relates to an electrocatalyst used in a fuel cell.

2. Description of the Related Art

Fuel cells have received more and more attention because of their high energy density and eco-friendly character. A fuel cell is a novel energy supply system having high versatility. Through an electrochemical reaction, chemical energy of fuel can promptly be transformed into electricity by a fuel cell when required. Electricity can be generated continuously as long as fuel is supplied. Hydrogen and methanol are the most commonly used fuels for a fuel cell. Since hydrogen and methanol are both renewable energy sources having no environmental pollution, if a fuel cell can be used as a replacement of a petrochemical energy source, the lifetime of remaining petrified energy can be extended. Now, fuel cells are mainly used in automobiles, stationary electrical supply equipment, and portable electronic products. Micro-fuel cells such as a direct-methanol fuel cell (DMFC) used in portable electronic products are the most commercialized and popular products.

A direct-methanol fuel cell is a kind of proton exchange membrane fuel cell (PEMFC.) In the cell, methanol and water are mixed and transferred to an anode, wherein a methanol oxidation reaction (MOR) occurs, thus producing carbon dioxide (CO₂), electrons, and protons. The protons and electrons are transferred to a cathode by a proton exchange membrane and external circuit respectively to perform an oxygen reduction reaction with oxygen, thus producing water and a direct current. Since the reactions at the anode and cathode are very slow at low temperature (operation temperature ≦80° C.), catalysts are needed to increase the reaction rate, to achieve the desirable electricity. That is, activity of the catalysts plays a key role that directly affects the efficiency of the cell and viability of commercialization.

Presently, the most efficient anode catalyst (such as PtRu) and cathode catalyst (such as Pt) both use Pt as the main component. However, the PtRu anode catalyst and the Pt cathode catalyst still have some disadvantages. For example, the catalytic performance of the PtRu anode catalyst with methanol is yet unsatisfactory. When the PtRu is used as a bimetal catalyst in a fuel cell, Pt is used to perform a dehyodrogenation reaction with methanol to release carbon monoxide (CO_{ads}), while Ru is used to catalyze water to release OH_{ad}, which is an intermediate for oxidizing carbon monoxide. The CO_{ads} absorbed on a Pt surface then reacts with adjacent OH_{ads} absorbed on an Ru surface to release CO₂, thus completing an anode methanol oxidation half reaction. However, since the catalytic activity of Ru with water is yet unsatisfactory, the Pt surface is poisoned by excessive CO, resulting in a decrease of the catalytic activity of the Pt catalyst with methanol.

On the other hand, although Pt is the most efficient catalyst for catalyzing a cathode oxygen reduction reaction, the un-reacted methanol (as described above) may be transferred to the cathode by a proton exchange membrane and may react with the Pt. The Pt and the methanol undergo an oxidation reaction, resulting in an electric potential that reduces the catalytic activity of the catalyst and poisons the Pt surface by CO.

Although some Pd-based catalysts, with lower reactivity to methanol and therefore better resistance to CO poisoning, have been proposed, their oxygen reduction ability is insufficient.

Therefore, a novel anode catalyst with high methanol catalytic activity and good resistance against CO poisoning and a new cathode catalyst with high oxygen reduction reaction activity and good resistance against CO poisoning are required to improve the power generation efficiency of fuel cells.

### BRIEF SUMMARY OF THE INVENTION

An embodiment of the invention provides an electrocatalyst, including a four-element catalyst having a formula of XYZP, wherein X is Pt or Pd, Y and Z are different elements selected from Group 6, Group 8, Group 9, or Group 11 elements, and P is phosphorous, wherein Group 6 elements include Cr, Mo, or W, Group 8 elements include Fe, Ru, or Os, Group 9 elements include Co, Rh, or Ir, and Group 11 elements include Cu, Ag, or Au.

Another embodiment of the invention provides a fuel cell, including: a cathode electrode; an anode electrode; an electrolyte disposed between the cathode electrode and the anode electrode; a cathode electrode catalyst layer disposed between the cathode electrode and the electrolyte; and an anode electrode catalyst layer disposed between the anode electrode and the electrolyte, wherein at least one of the cathode electrode catalyst layer and the anode electrode catalyst layer includes the above described electrocatalyst.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is cross section of a fuel cell according to one embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In the disclosure, a four-element electrocatalyst with improved catalytic activity and stability is provided. The four-element electrocatalyst has a general formula of XYZP, wherein X is Pt or Pd, Y and Z are different elements selected from Group 6, Group 8, Group 9, or Group 11 elements, and P is phosphorous. The Group 6 elements include Cr, Mo, or W. The Group 8 elements include Fe, Ru, or Os. The Group 9 elements include Co, Rh, or Ir. The Group 11 elements include Cu, Ag, or Au.

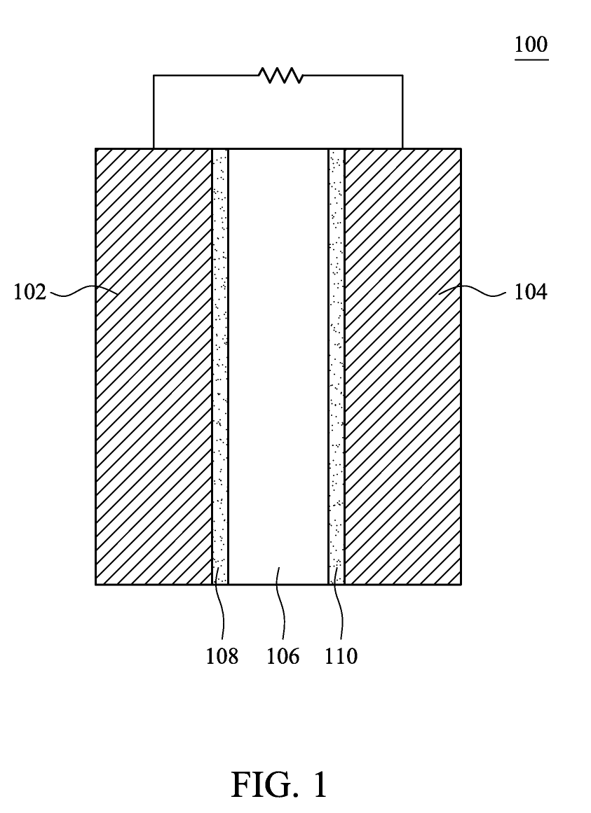

FIG. 1 illustrates a fuel cell 100 according to one embodiment of the disclosure. The fuel cell 100 includes an anode electrode 102, a cathode electrode 104, and a proton exchange membrane 106, wherein the proton exchange membrane 106 is disposed between the anode electrode 102 and the cathode electrode 104. An anode electrode catalyst layer 108 is disposed between the anode electrode 102 and the proton exchange membrane 106. A cathode electrode catalyst layer 110 is disposed between the cathode electrode 104 and the proton exchange membrane 106. The anode electrode 102, the cathode electrode 104, and the proton exchange membrane 106 may be any well-known or future developed electrodes and proton exchange membranes of fuel cells. For example, the electrode sets described in Taiwan patents TW M385103, TW 1338408, or TW 1244792 may be employed.

A cathode electrode catalyst layer is formed by loading (such as adsorbing) a cathode electrode catalyst on a carrier. The cathode electrode catalyst is a four-element catalyst having a formula of XYZP, wherein X is Pd, Y and Z are different elements selected from Group 6 or Group 9 elements, and P is phosphorous. Examples of the cathode electrode catalyst include, but are not limited to, PdCoWP, PdCoCrP, PdCoMoP, PdRhWP, PdRhCrP, PdRhMoP, PdIrWP, PdIrCrP, PdIrMoP, PdCrWP, PdCrMoP, PdMoWP, PdCoRhP, PdCoIrP, or PdRhIrP. An atomic ratio of X:Y:Z:P may be, but are not limited to, between 30-97:1-60:1-50:0.01-30, or between 35-90:5-55:5-40:1-20.

An anode electrode catalyst layer is formed by loading (such as adsorbing) an anode electrode catalyst on a carrier. The anode electrode catalyst is a four-element catalyst having a formula of XYZP, wherein X is Pt, Y and Z are different elements selected from Group 6, Group 8, or Group 11 elements, and P is phosphorous. Examples of the anode electrode catalyst include, but are not limited to, PtRuWP, PtRuMoP, PtRuCrP, PtRuAuP, PtRuAgP, PtRuCuP, PtRuFeP, PtRuOsP, PtFeWP, PtFeMoP, PtFeCrP, PtFeAuP, PtFeAgP, PtFeCuP, PtFeOsP, PtOsWP, PtOsMoP, PtOsCrP, PtOsAuP, PtOsAgP, or PtOsCuP. An atomic ratio of X:Y:Z:P may be, but are not limited to, between 30-70:30-70:0.01-30:0.01-30, or between 35-60:35-60:0.05-20:0.05-20.

In addition, the cathode and anode electrode catalyst are loaded on the carrier, wherein examples of the carrier include, but are not limited to, activated carbon, carbon black, carbon nanoparticles, carbon nanotube, carbon nano-fiber, furnace black, graphitized carbon black, graphite, or combinations thereof. In one embodiment, the carrier may have a surface area between, but not limited to, 10 and 2000 m²/g, and a loading amount of the electrocatalyst loaded on the carrier may be between, but not limited to, 10 and 90%. Any catalyst precursor having the catalyst elements can be used to prepare the catalyst, and it is not limited to the catalyst precursor described in the examples.

Conventionally, the cathode electrode catalyst, such as Pt, may have good catalytic activity at the beginning, but its catalytic activity may decrease, or even completely be lost, because of the CO and/or methanol poisoning. Moreover, Pt is costly which limits its applications. Although Pd is cheaper and may be a substitute for Pt to reduce the cost, the catalytic activity of Pd is too low such that Pd can not be used as a good cathode electrode catalyst. Surprisingly, the oxygen reduction reaction catalytic activity of the four-element catalyst of the invention is higher than that of a commercial Pt catalyst. In addition, the four-element catalysts of the invention have much better CO and/or methanol poisoning resistance. In particular, the four-element catalysts containing Pd, such as PdCoWP, have higher catalytic activity when compared to the two-element or three element catalysts containing Pd, and have very high resistance toward CO and/or methanol poisoning. Moreover, the cost of the four-element catalysts containing Pd described above is only one-third to one-fourth the cost of the commercial Pt catalyst. In conclusion, the catalytic activity, resistance toward CO and/or methanol poisoning, and catalyst stability of the four-element catalysts containing Pd are all superior to that of the commercial Pt catalysts.

Commercial anode electrode catalysts, such as PtRu, do not have sufficient catalytic activity, and also suffer from the problem of CO poisoning. In addition, the catalytic stability of the PtRu is poor, and may lose its catalytic stability after a period of operation time. In comparison, the four-element catalysts of the current invention possess both high catalytic activity and stability and can maintain a desirable catalytic activity after a period of operation time.

Furthermore, the catalyst layer containing the four-element catalysts may only be disposed on one of the anode electrode and the cathode electrode, while on the other electrode, any known electrocatalyst can be disposed thereon.

### Examples 1-4

### Synthesis of Cathode Electrode Catalysts

Ketjen Black ECP300 was used as the catalyst carrier and was dispersed into ethylene glycol. Precursors including PdCl₂, Co(NO₃)₂.6H₂O, (NH₄)₆W₁₂O₃₉.xH₂O (Ammonium tungsten oxide hydrate), and NaH₂PO₂.H₂O were weighted (according to Table 1) and dissolved in an NaCl aqueous solution to form an aqueous metal salt solution. The aqueous metal salt solution was added into the ethylene glycol containing the carrier and uniformly dispersed. Then, the solution was stirred by a stirrer and refluxed for 2 hours at 150° C., such that the metal salts were reduced to metal nanoparticles and adsorbed onto the carrier. The temperature of the solution was then lowered to room temperature. The solution was then filtered, and the filter cake was washed with water, resulting in the cathode electrode catalyst of example 1, wherein the atomic ratio of Pd:Co:W:P was 68:15:10:7.

The cathode electrode catalysts of examples 2-4 were also formed by the method described above except that different amounts of metal salt precursors were used (referring to table 1.) In examples 1 and 2, the loading amount of the catalysts on carbon was 65 wt %. In examples 3 and 4, the loading amount of the catalysts on carbon was 40 wt %. Table 1 illustrates the catalytic activity of oxygen reduction reaction (ORR) measured by dispersing the resulting cathode electrode catalysts of examples 1-4 on a rotating glassy carbon electrode, followed by immersing it into a 0.5M of H₂SO_{4(aq)} at 40° C. Moreover, commercial Pt catalysts (Johnson Matthey Corp.) with different loading were used as comparative examples 1 and 2. Referring to Table 1, the oxygen reduction reaction catalytic activity of the four-element catalyst PdCoWP, with different atomic ratio and loading amounts, are all higher than those of the commercial Pt catalysts (comparative examples 1 and 2) at a voltage of 0.75V.

TABLE 1
Oxygen reduction reaction catalytic activity of catalysts with
different atomic ratio and loading (40° C., 0.5M H₂SO₄)

| | Loading | | Activity | Activity |
|---|---|---|---|---|
| | amount | Pd:Co:W:P | at 0.8 V | at 0.75 V |
| Sample | (wt %) | (at %) | (A/g) | (A/g) |
| Example 1 | 65 | 68:15:10:7 | 46.8 | 67.6 |
| Example 2 | 65 | 37:48:10:5 | 39.7 | 60.9 |
| Example 3 | 40 | 72:16:10:2 | 45.8 | 72.1 |
| Example 4 | 40 | 46:40:9:5 | 44.1 | 70.1 |
| Comparative | 70 | Commercial Pt | 42.8 | 47.8 |
| Example 1 | | | | |
| Comparative | 40 | Commercial Pt | 37.7 | 45.2 |
| Example 2 | | | | |

In addition, catalysts of examples 1-4 and comparative examples 1-2 were placed into a 1M methanol solution, and were tested for their catalytic activity of oxygen reduction reaction under a methanol environment using rotating glassy carbon electrodes. Table 2 illustrates the results, wherein the four-element catalyst PdCoWP still maintained good catalytic activity under a methanol environment. However, the commercial Pt catalysts were poisoned by CO and had no activity.

TABLE 2
Oxygen reduction reaction catalytic activity of catalysts with different
atomic ratio and loading (40° C., 1M CH₃OH + 0.5M H₂SO₄)

| | Loading | | Activity | Activity |
|---|---|---|---|---|
| | amount | Pd:Co:W:P | at 0.8 V | at 0.75 V |
| Sample | (wt %) | (at %) | (A/g) | (A/g) |
| Example 1 | 65 | 68:15:10:7 | 41.4 | 52.5 |
| Example 2 | 65 | 37:48:10:5 | 24.5 | 53.5 |
| Example 3 | 40 | 72:16:10:2 | 21.2 | 54.8 |
| Example 4 | 40 | 46:40:9:5 | 28.9 | 55.2 |
| Comparative | 70 | Commercial Pt | Inactive | Inactive |
| Example 1 | | | | |
| Comparative | 40 | Commercial Pt | Inactive | Inactive |
| Example 2 | | | | |

### Example 5

### Calcination of Cathode Electrode Catalysts

The sample of example 1 was calcined for 2 hours at 500° C. in a reducing atmosphere to obtain the catalyst of example 5. In addition, comparative examples 3-5 were also prepared.

### Comparative Examples 3-5

The same procedure as in example 1 was repeated in the comparative examples except that the atomic ratio listed in table 3 was used. Precursors including PdCl₂, Co(NO₃)₂.6H₂O, and (NH₄)₆W₁₂O₃₉.xH₂O (Ammonium tungsten oxide hydrate) were weighted to obtain a three-element catalyst PdCoW. The PdCoW catalyst was further calcined for 2 hours at 500° C. in a reducing atmosphere, thus obtaining the catalyst of comparative example 3. Likewise, precursors including PdCl₂, Co(NO₃)₂.6H₂O, and NaH₂PO₂.H₂O were weighted to form a three-element catalyst PdCoP. The PdCoP catalyst was further calcined for 2 hours at 500° C. in a reducing atmosphere, thus obtaining the catalyst of comparative example 4. Also, precursors including PdCl₂ and Co(NO₃)₂.6H₂O were weighted to form a two-element catalyst PdCo. The PdCo was further calcined for 2 hours at 500° C. in a reducing atmosphere, thus obtaining the catalyst of comparative example 5.

Table 3 illustrates the oxygen reduction reaction catalytic activity of the four-element, three-element, and two-element catalysts under 0.5M H₂SO₄. The result of example 1, wherein the catalyst was not calcined, is also shown in table 3 for comparison. As shown in table 3, catalysts of examples 1 and 5 showed no activity lost after being calcined, thereby still had good catalytic activity. Compared to comparative examples 3-5, the four-element catalysts containing Pd, before and after calcination, had better catalytic activity when compared to the three-element catalysts containing Pd (PdCoW and PdCoP) and two-element catalyst containing Pd (PdCo.)

Furthermore, table 4 illustrates the oxygen reduction reaction catalytic activity of the catalysts of example 1, example 5, and comparative examples 3-5 under the 1M methanol solution. As shown in table 4, compared to the catalysts containing Pt, the catalysts containing Pd had better resistance toward CO and/or methanol poisoning under a methanol environment, wherein the four-element catalysts of examples 1 and 5 still had the highest catalytic activities.

TABLE 3
Oxygen reduction reaction catalytic activity of catalysts with different composition
after being calcined (40° C., 0.5M H₂SO₄)

| | Loading | | | calcination | | Activity |
|---|---|---|---|---|---|---|
| | amount | | Atomic | temperature | Activity | at 0.75 V |
| Sample | (wt %) | Composition | ratio (at %) | (° C.) | at 0.8 V (A/g) | (A/g) |
| Example 1 | 65 | Pd:Co:W:P | 68:15:10:7 | Without | 46.8 | 67.6 |
| | | | | calcination | | |
| Example 5 | 65 | Pd:Co:W:P | 68:15:10:7 | 500 | 51.7 | 68.7 |
| Comparative | 64 | Pd:Co:W | 70:20:10 | 500 | 36.0 | 54.1 |
| Example 3 | | | | | | |
| Comparative | 65 | Pd:Co:P | 70:25:5 | 500 | 26.7 | 38.7 |
| Example 4 | | | | | | |
| Comparative | 61 | Pd:Co | 70:30 | 500 | 25.1 | 45.6 |
| Example 5 | | | | | | |

TABLE 4
Oxygen reduction reaction catalytic activity of catalysts with different composition
after being calcined (40° C., 1M CH₃OH + 0.5M H₂SO₄)

| | Loading | | | calcination | Activity | Activity |
|---|---|---|---|---|---|---|
| | amount | | Atomic ratio | temperature | at 0.8 V | at 0.75 V |
| Sample | (wt %) | Composition | (at %) | (° C.) | (A/g) | (A/g) |
| Example 1 | 65 | Pd:Co:W:P | 68:15:10:7 | Without | 41.1 | 52.2 |
| | | | | calcination | | |
| Example 5 | 65 | Pd:Co:W:P | 68:15:10:7 | 500 | 37.5 | 50.2 |
| Comparative | 64 | Pd:Co:W | 70:20:10 | 500 | 21.2 | 42.2 |
| Example 3 | | | | | | |
| Comparative | 65 | Pd:Co:P | 70:25:5 | 500 | 20.9 | 32.1 |
| Example 4 | | | | | | |
| Comparative | 61 | Pd:Co | 70:30 | 500 | 17.4 | 24.5 |
| Example 5 | | | | | | |

### Stability of the Cathode Electrode Catalysts

Table 5 illustrates the catalytic activity of the four-element catalyst, the two-element catalyst, and the three-element catalysts at 0.7V. As shown in table 5, after discharging for three hours, the three-element catalyst of the comparative example 4 (PdCoP) barely discharged. The activity of the three-element catalyst of the comparative example 3 (PdCoW) was only slightly better than the comparative example 1 (commercial Pt catalyst.) However, the activity of the four-element catalyst of example 5 (PdCoWP) was 34.3 A/g, which was about twice of the activity of the comparative example 1 (commercial Pt catalyst.)

TABLE 5
Stability of the cathode electrode catalysts (0.7 V, 40° C., 0.5M H₂SO₄)

| | Loading | | Activity after | Activity after | Activity after |
|---|---|---|---|---|---|
| | amount | | reacting for 1 | reacting for 3 | reacting for 6 |
| Sample | (wt %) | Composition | hr (A/g) | hrs (A/g) | hrs (A/g) |
| Example 5 | 65 | Pd:Co:W:P | 44.8 | 34.3 | 28.2 |
| Comparative | 64 | Pd:Co:W | 26.6 | 21.9 | 17.9 |
| Example 3 | | | | | |
| Comparative | 65 | Pd:Co:P | 5.9 | 0.7 | Not active |
| Example 4 | | | | | |
| Comparative | 61 | Pd:Co | 20.4 | 9.7 | 7.0 |
| Example 5 | | | | | |
| Comparative | 70 | Commercial Pt | 28.9 | 19.5 | 16.4 |
| Example 1 | | | | | |

Table 6 illustrates the activity of example 5 and comparative examples 1, 3-5 in methanol solution at 0.7V. The commercial Pt catalyst (comparative example 1) and the three-element catalyst of comparative example 4 (PdCoP) were poisoned by CO and/or methanol and stopped discharging after reaction for three hours. However, the activity of the four-element catalyst of example 5 still achieved 32.6 A/g after reaction for three hours. It is clear that the four-element catalyst of example 5 possesses high catalytic activity, high stability, and high resistance toward CO and/or methanol poisoning. Moreover, the price of Pd is only one-third to one-fourth the price of Pt, and therefore the catalyst cost can be reduced.

TABLE 6
Stability of the cathode electrode catalysts (0.7 V, 40° C., 1M CH₃OH + H₂SO₄)

| | Loading | | Activity after | Activity after | Activity after |
|---|---|---|---|---|---|
| | amount | | reacting for 1 | reacting for 3 | reacting for 6 |
| Sample | (wt %) | Composition | hr (A/g) | hrs (A/g) | hrs (A/g) |
| Example 5 | 65 | Pd:Co:W:P | 42.2 | 32.6 | 26.6 |
| Comparative | 64 | Pd:Co:W | 25.8 | 16.1 | 8.0 |
| Example 3 | | | | | |
| Comparative | 65 | Pd:Co:P | 0.2 | Not active | Not active |
| Example 4 | | | | | |
| Comparative | 61 | Pd:Co | 13.8 | 8.7 | Not active |
| Example 5 | | | | | |
| Comparative | 70 | Commercial Pt | Not active | Not active | Not active |
| Example 1 | | | | | |

### Examples 6-8

### Synthesis of Anode Electrode Catalysts

The same procedure as in example 1 was repeated in example 6 PtRuWP except that the atomic ratio listed in table 7 was used, wherein Ketjen Black ECP300 was used as the carrier and H₂PtCl₆.6H₂0, RuCl₃, (NH₄)₆W₁₂O₃₉.xH₂O, and NaH₉PO₂.H₂O were weighted as precursors according to the ratio in table 7. In addition, catalysts of example 7 (PtRuAuP) and example 8 (PtRuCuP) were also synthesized by using HAuCl₄.3H₂O and CuCl₂.2H₂O to replace (NH₄)₆W₁₂O₃₉.xH₂O of example 6. Table 7 illustrates the activity of the four-element cathode electrode catalysts, wherein all of the four-element anode electrode catalysts achieved good catalytic activity toward methanol oxidation reaction.

TABLE 7
Methanol oxidation reaction catalytic activity of anode electrode catalysts
(40° C., 5M CH₃OH + 0.5M H₂SO₄)

| | Loading | | | Activity at | | Activity at |
|---|---|---|---|---|---|---|
| | amount | | | 0.35 V | Activity at | 0.45 V |
| Sample | (wt %) | Composition | Ratio (at %) | (A/g) | 0.4 V (A/g) | (A/g) |
| Example 6 | 72 | PtRuWP | Pt:Ru:W:P = | 6.6 | 22.0 | 67.0 |
| | | | 46:46:1:7 | | | |
| Example 7 | 72 | PtRuAuP | Pt:Ru:Au:P = | 6.3 | 22.2 | 71.0 |
| | | | 46:46:1:7 | | | |
| Example 8 | 72 | PtRuCuP | Pt:Ru:Cu:P = | 5.7 | 21.4 | 65.9 |
| | | | 45:45:3:7 | | | |

### Comparative Examples

### 6-9

Three-element catalysts PtRuW (comparative example 6) and PtRuP (comparative example 7) were synthesized by the method described previously. Commercial two-element catalysts PtRu were also provided as comparative examples 8 (Johnson Matthey Corp.) and comparative examples 9 (TANAKA Corp.), wherein the atomic ratio of Pt:Ru of comparative examples 8 and 9 were 1:1 and 1:1.5, respectively. Referring to table 8, the activity of the four-element cathode electrode catalyst was better than the three-element and the two-element catalysts.

In addition, table 9 illustrates the stability of the four-element, three-element, and two-element catalysts at 40° C. at 0.4V in 5M CH₃OH solution. Compared to the two-element and three-element catalysts, the four-element cathode electrode catalyst of example 6 had the best stability.

TABLE 8
Methanol oxidation reaction activity of the four-element, three-element, and two-
element anode electrode catalysts (40° C., 5M CH₃OH + 0.5M H₂SO₄)

| | Loading | | | Activity | | Activity at |
|---|---|---|---|---|---|---|
| | amount | | | at 0.35 V | Activity at | 0.45 V |
| Sample | (wt %) | Composition | Ratio (at %) | (A/g) | 0.4 V (A/g) | (A/g) |
| Example 6 | 72 | PtRuWP | Pt:Ru:W:P = | 6.6 | 22.0 | 67.0 |
| | | | 46:46:1:7 | | | |
| Comparative | 71 | PtRuW | Pt:Ru:W = | 6.3 | 17.2 | 50.2 |
| Example 6 | | | 49.5:49.5:1 | | | |
| Comparative | 71 | PtRuP | Pt:Ru:P = | 3.9 | 16.3 | 61.7 |
| Example 7 | | | 46.5:46.5:7 | | | |
| Comparative | 70 | Commercial | Pt:Ru = 50:50 | 5.3 | 20.2 | 65.8 |
| Example 8 | | PtRu | | | | |
| Comparative | 70 | Commercial | Pt:Ru = 40:60 | 1.9 | 20.0 | 64.8 |
| Example 9 | | PtRu | | | | |

TABLE 9
Stability of the four-element, three-element, and two-element anode electrode
catalysts (40° C., 5M CH₃OH + 0.5M H₂SO₄)

| | | | | Activity | Activity | Activity |
|---|---|---|---|---|---|---|
| | Loading | | | after reacting | after reacting | after reacting |
| | amount | | | for 1 hr | for 2 hr | for 3 hr |
| Sample | (wt %) | Composition | Ratio (at %) | (A/g) | (A/g) | (A/g) |
| Example 6 | 72 | PtRuWP | Pt:Ru:W:P = | 6.5 | 3.4 | 2.0 |
| | | | 46:46:1:7 | | | |
| Comparative | 71 | PtRuW | Pt:Ru:W = | 5.1 | 3.0 | 1.9 |
| Example 6 | | | 49.5:49.5:1 | | | |
| Comparative | 70 | Commercial | Pt:Ru = 50:50 | 3.1 | 0.5 | 0 |
| Example 7 | | PtRu | | | | |
| Comparative | 70 | Commercial | Pt:Ru = 40:60 | 3.7 | 1.7 | 0.4 |
| Example 8 | | PtRu | | | | |

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electro catalyst, comprising a four-element catalyst having a formula of XYZP, wherein X is Pt or Pd, Y and Z are different elements selected from Group 6, Group 8, Group 9, or Group 11 elements, and P is phosphorous, wherein Group 6 elements comprise Cr, Mo, or W, Group 8 elements comprise Fe, Ru, or Os, Group 9 elements comprise Co, Rh, or Ir, and Group 11 elements comprise Cu, Ag, or Au.

2. The electrocatalyst as claimed in claim 1, wherein the four-element catalyst is a cathode catalyst for a fuel cell, wherein X is Pd, and Y, Z are different elements selected from Group 6 or Group 9 elements.

3. The electrocatalyst as claimed in claim 1, wherein the four-element catalyst is an anode catalyst for a fuel cell, wherein X is Pt, and Y, Z are different elements selected from Group 6, Group 8, or Group 11 elements.

4. The electrocatalyst as claimed in claim 2, wherein Y is Co and Z is W.

5. The electrocatalyst as claimed in claim 3, wherein Y is Ru, and Z is W, Au, or Cu.

6. A fuel cell, comprising:
a cathode electrode;
an anode electrode;
an electrolyte disposed between the cathode electrode and the anode electrode;
a cathode electrode catalyst layer disposed between the cathode electrode and the electrolyte; and
an anode electrode catalyst layer disposed between the anode electrode and the electrolyte,
wherein at least one of the cathode electrode catalyst layer and the anode electrode catalyst layer comprises the electrocatalyst as claimed in claim 1.

7. The fuel cell as claimed in claim 6, wherein the cathode electrode catalyst layer is disposed on the cathode electrode, wherein X is Pd, and Y, Z are different elements selected from Group 6 or Group 9 elements.

8. The fuel cell as claimed in claim 6, wherein the anode electrode catalyst layer is disposed on the anode electrode, wherein X is Pt, and Y, Z are different elements selected from Group 6, Group 8, or Group 11 elements.

9. The fuel cell as claimed in claim 7, wherein Y is Co and Z is W.

10. The fuel cell as claimed in claim 8, wherein Y is Ru, and Z is W, Au, or Cu.

11. The fuel cell as claimed in claim 6, wherein the electrocatalyst is loaded on a carrier.

12. The fuel cell as claimed in claim 11, wherein the carrier comprises activated carbon, carbon black, carbon nanoparticles, carbon nanotube, carbon nano-fiber, furnace black, graphitized carbon black, graphite, or combinations thereof.

13. The fuel cell as claimed in claim 11, wherein the carrier has a surface area between 10 and 2000 m²/g.

14. The fuel cell as claimed in claim 11, wherein a loading amount of the electrocatalyst loaded on the carrier is between 10 and 90%.
